(19) United States
(12) Patent Application Publication
(10) Pub. No.: US 2015/0226418 A1
(43) Pub. Date: Aug. 13, 2015

(54) LED LIGHT EMITTING DEVICE

(71) Applicants: TSANN KUEN ZHANGZHOU, Fujian (CN); DST TECHNOLOGY CO., LTD., Tainan City (TW)

(72) Inventors: Chi-Ting CHEN, Tainan City (TW); Tao-Hung CHOU, New Taipei City (TW)

(73) Assignees: TSANN KUEN ZHANGZHOU, Fujian (CN); DST TECHNOLOGY CO., LTD., Tainan City (TW)

(21) Appl. No.: 14/291,346

(22) Filed: May 30, 2014

(30) Foreign Application Priority Data
Feb. 10, 2014 (CN) 201410046367.7

(51) Int. Cl. F21V 29/89; F21V 23/00; F21V 23/02; F21K 99/00

(52) U.S. Cl. CPC F21V 29/89; F21K 9/56; F21V 23/006; F21V 23/02

(57) ABSTRACT

A LED light emitting device includes a heat dissipating substrate, a heat reflective layer disposed on the heat dissipating substrate, a circuit unit disposed on the heat dissipating substrate and spaced apart from the heat reflective layer, and a LED chip unit insulatively disposed on the heat reflective layer and electrically connected to the circuit unit.

### CROSS-REFERENCE TO RELATED APPLICATION

This application claims priority of Chinese Patent Application No. 201410046367.7, filed on Feb. 10, 2014, the entire disclosure of which is hereby incorporated by reference.

### BACKGROUND OF THE INVENTION

1. Field of the Invention

This invention relates to a light emitting device, more particularly to a LED light emitting device.

2. Description of the Related Art

Referring to FIG. 1, a conventional LED light emitting device includes a metallic heat dissipating substrate 11, a lower copper layer 12 disposed on the metallic heat dissipating substrate 11, an insulating layer 13 disposed on the lower copper layer 12 oppositely of the heat dissipating substrate 11, an upper copper layer 14 disposed on the insulating layer 13 oppositely of the lower copper layer 12, and a plurality of spaced-apart LED chips 15 disposed on and electrically connected to the upper copper layer 14. The metallic heat dissipating substrate 11 is designed to dissipate the heat generated by the LED chips 15. However, the insulating layer 13 disposed between the lower copper layer 12 and the upper copper layer 14 has a relatively poor heat conductivity and therefore adversely affects the heat conduction between the LED chips 15 and the heat dissipating substrate 11, thereby resulting in a reduction in the service life of the conventional LED light emitting device.

### SUMMARY OF THE INVENTION

Therefore, the object of the present invention is to provide a LED light emitting device that can overcome the aforesaid drawback of the prior art.

According to this invention, a LED light emitting device includes a heat dissipating substrate, a heat reflective layer disposed on the heat dissipating substrate, a circuit unit disposed on the heat dissipating substrate and spaced apart from the heat reflective layer, and a LED chip unit insulatively disposed on the heat reflective layer and electrically connected to the circuit unit.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a fragmentary sectional view of a conventional LED light emitting device;

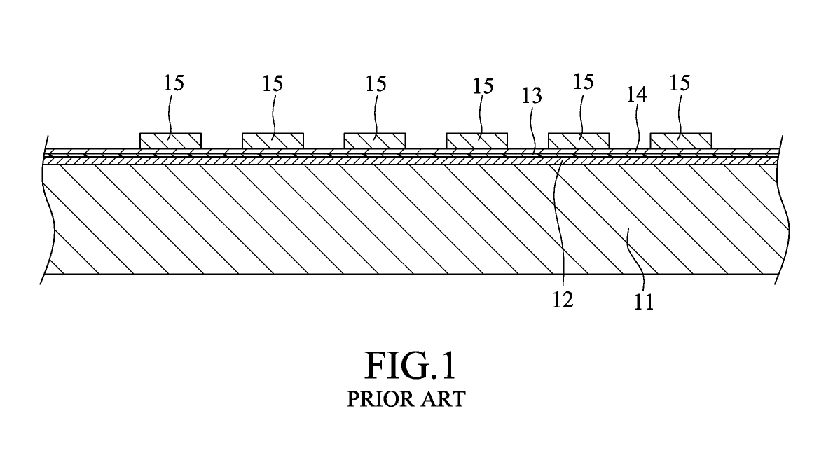

FIG. 2 is a top view of the preferred embodiment of a LED light emitting device according to this invention;

FIG. 3 is a fragmentary sectional view of the preferred embodiment; and

FIG. 4 is a fragmentary sectional enlarged view of FIG. 3.

### DETAILED DESCRIPTION OF THE PREFERRED EMBODIMENT

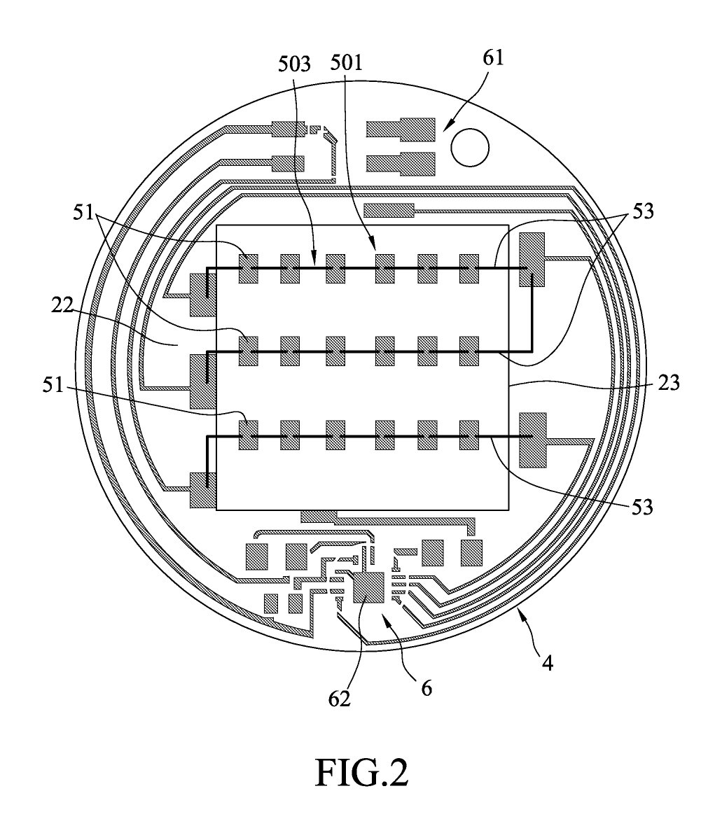

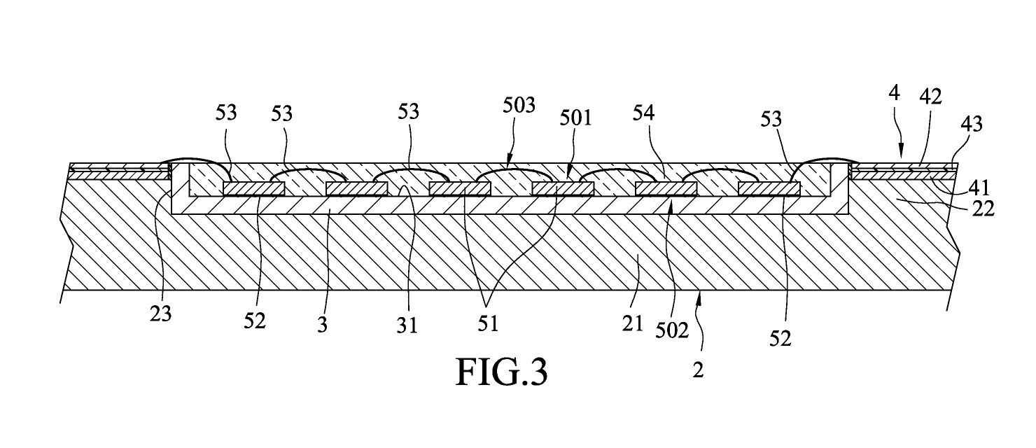

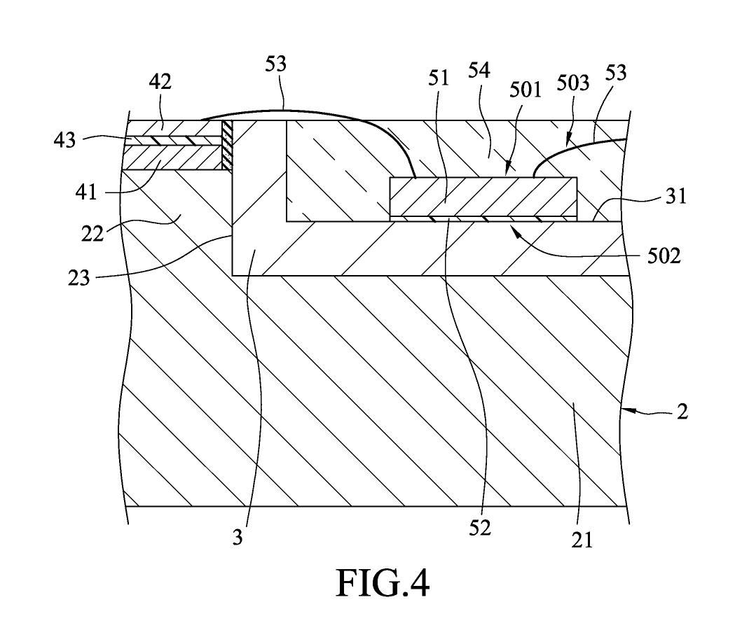

Referring to FIGS. 2, 3 and 4, the preferred embodiment of a LED light emitting device according to the present invention includes a heat dissipating substrate 2, a heat reflective layer 3 disposed on the heat dissipating substrate 2, a circuit unit 4 disposed on the heat dissipating substrate 2 and spaced apart from the heat reflective layer 3, and a LED chip unit 501 insulatively disposed on the heat reflective layer 3 and electrically connected to the circuit unit 4.

The heat dissipating substrate 2 is used for dissipating the heat generated by the LED chip unit 501, and is preferably made of metal, e.g., aluminum. In this embodiment, the heat dissipating substrate 2 is configured as a disk, and has a central portion 21 and a surrounding portion 22 extending upwardly from a periphery of the central portion 21 so as to define an indentation 23 in the heat dissipating substrate 2. In this embodiment, the indentation 23 is configured as a rectangle. However, it should be noted that the shapes of the heat dissipating substrate 2 and the indentation 23 are not limited and may vary based on actual requirements.

The heat reflective layer 3 is made of metal, is located in the indentation 23 of the heat dissipating substrate 2, and has a reflective surface 31 that is smooth and that is capable of reflecting light and heat generated by the LED chip unit 501 away from the heat dissipating substrate 2 toward an exterior environment through radiation. The heat reflective layer 3 may be deposited on the heat dissipating substrate 2 using vacuum deposition. Examples of the metal for the heat reflective layer 3 include nickel and silver.

The circuit unit 4 is disposed on the surrounding portion 22 of the heat dissipating substrate 2. In this embodiment, the circuit unit 4 includes a lower copper layer 41 disposed on a top surface of the surrounding portion 22 of the heat dissipating substrate 2, an insulating layer 43 disposed on the lower copper layer 41 oppositely of the heat dissipating substrate 2, and an upper copper layer 42 disposed on the insulating layer 43 oppositely of the lower copper layer 41. Since the structure of the circuit unit 4 of the LED light emitting device is well known to a skilled artisan, a detailed description thereof is omitted herein for the sake of brevity.

The LED chip unit 501 includes a plurality of LED chips 51 that are spaced apart from each other.

The LED light emitting device further includes an insulating adhesive unit 502 for adhesion of the LED chip unit 501 to the heat reflective layer 3, and a conductive wire unit 503 electrically connecting the LED chip unit 501 to the circuit unit 4. The insulating adhesive unit 502 includes a plurality of insulating adhesives 52 that are respectively disposed between the LED chips 51 and the heat reflective layer 3. The conductive wire unit 503 includes a plurality of conductive wires 53 to interconnect the LED chips 51 and connect some of the LED chips 51 to the upper copper layer 42 so as to achieve electrical connection between the LED chip unit 501 and the circuit unit 4. It should be noted that the numbers of the LED chips 51, the insulating adhesives 52 and the conductive wires 53 are not limited and may vary to meet actual requirements.

The LED light emitting device further includes a fluorescent layer 54 encapsulating the LED chip unit 501. The fluorescent layer 54 is light-transmissible and is capable of filtering light and/or improving uniform luminance.

The LED light emitting device further includes an electronic mechanism 6 that is disposed on and electrically connected to the circuit unit 4. The electronic mechanism 6 includes a processor 62 for current control and a rectifier 61 for converting alternating current to direct current.

In use, when the light emitting device is turned on, heat generated by the LED chips 51 is partly reflected by the heat reflective layer 3 via heat radiation and is partly conducted by the heat reflective layer 3 to the heat dissipating substrate 2 via heat conduction. Since the insulating layer 43 of the circuit unit 4 is spaced apart from the LED chips 51, the insulating layer 43 will not adversely affect the heat dissipation between the LED chips 51 and the heat dissipating substrate 2 so that the undesired heat can be effectively dissipated.

In addition, part of the light illuminated from the LED chips 51 and traveling to the heat reflective layer 3 could be reflected by the heat reflective layer 3 toward a direction away from the indentation 23 so that the illuminating efficiency of the LED light emitting device could be improved. Moreover, with the arrangement of the LED chip unit 501 in the indentation 23 of the heat dissipating substrate 2, the rectifier 61 and the processor 62 disposed on the surrounding portion 22 of the heat dissipating substrate 2 would not be adversely affected by the heat generated by the LED chip unit 501 so that the rectifier 61 and the processor 62 are able to be disposed at a position adjacent to the LED chips 51. As such, the size of the LED light emitting device according to this invention can be minimized.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A LED light emitting device comprising:
a heat dissipating substrate;
a heat reflective layer disposed on said heat dissipating substrate;
a circuit unit disposed on said heat dissipating substrate and spaced apart from said heat reflective layer; and
a LED chip unit insulatively disposed on said heat reflective layer and electrically connected to said circuit unit.

2. The LED light emitting device as claimed in claim 1, further comprising an electronic mechanism that includes a processor for current control, and a rectifier for converting alternating current to direct current, said processor and said rectifier being disposed on and electrically connected to said circuit unit.

3. The LED light emitting device as claimed in claim 1, wherein said heat dissipating substrate is formed with an indentation, said heat reflective layer being located in said indentation.

4. The LED light emitting device as claimed in claim 1, further comprising a fluorescent layer that encapsulates said LED chip unit.

5. The LED light emitting device as claimed in claim 1, wherein said heat reflective layer is made of metal.

6. The LED light emitting device as claimed in claim 1, wherein said heat reflective layer is deposited on said heat dissipating substrate using vacuum deposition.

7. The LED light emitting device as claimed in claim 5, wherein the metal of said heat reflective layer is selected from the group consisting of nickel, silver, and the combination thereof.

8. The LED light emitting device as claimed in claim 1, further comprising a conductive wire unit electrically connecting said LED chip unit to said circuit unit.

9. The LED light emitting device as claimed in claim 1, further comprising an insulating adhesive unit for adhesion of said LED chip unit to said heat reflective layer.

10. The LED light emitting device as claimed in claim 1, wherein said circuit unit includes a lower copper layer disposed on said heat dissipating substrate, an insulating layer disposed on said lower copper layer oppositely of said heat dissipating substrate, and an upper copper layer disposed on said insulating layer oppositely of said lower copper layer.

11. The LED light emitting device as claimed in claim 1, wherein said heat dissipating substrate is made of metal.
